(19) United States
(12) Patent Application Publication
(10) Pub. No.: US 2015/0249692 A1
(43) Pub. Date: Sep. 3, 2015

(54) SYSTEM AND METHOD FOR CONTACT QUEUE MANAGEMENT

(71) Applicant: Cisco Technology, Inc., San Jose, CA (US)

(72) Inventor: Jayaram Sankaranarayanan, Bangalore (IN)

(73) Assignee: Cisco Technology, Inc., San Jose, CA (US)

(21) Appl. No.: 14/193,006

(22) Filed: Feb. 28, 2014

(51) Int. Cl. H04L 29/06; G06Q 10/06

(52) U.S. Cl. CPC H04L 65/1066; G06Q 10/063114; H04L 65/403

(57) ABSTRACT

In one embodiment, a support handling system receives an incoming support communication from an user, and the session is identified. The session is associated with a primary queue corresponding to a mode of the incoming communication request. The session is assigned a position in the primary queue in accordance with preexisting queue communication sessions and other parameters. The system estimates a primary hold time associated with the primary queue position and alternative hold time associated if the session continued via a second communication mode. The user is prompted to select a desired queue in accordance with the hold times or queue positions. The selection specifies which queue is to be used. The queue selection establishes a continued communication session with the associated user via the first communication mode or an alternative communication mode. The system assigns a secondary queue position in the secondary queue corresponding to the initial queue position.

### TECHNICAL FIELD

The present disclosure relates generally to handling of support sessions via alternative communication modes.

### BACKGROUND

Businesses will frequently offer support to their customers or users. By way of example, support may be in connection with questions or problems relating to any product or service offering. Support is particularly useful in connection with complex products, such as electric or electronic products, software products, or computer hardware products. Support may also be provided for technical services such as on-line access, cable television or telephone. Still other support services may be offered in connection with areas such as banking, investing, or insurance.

In the past, support, such as customer support, was typically provided by publishing a support phone number for individuals to call. Large numbers of callers could quickly overwhelm available support personnel or support lines. Rather than reject incoming calls, automated calling queues were implemented wherein a user could wait in turn for a next available support person. While support queues allowed a user to wait for support in turn, there may still be lengthy hold times before reaching a human contact.

### BRIEF DESCRIPTION OF THE FIGURES

FIG. 1 is an example of support contact handling system;

FIG. 2 is a block diagram illustrating an example of a computer system upon which an example embodiment may be implemented;

FIG. 3 is another example of a support contact handling system;

FIG. 4 is an example of a queue manager;

FIG. 5 is an example of information association in a queue; and

FIG. 6 is an example of a flow diagram of a support contact handling system.

### DESCRIPTION OF EXAMPLE EMBODIMENTS

### Overview

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In an example embodiment as described herein, a support handling system and associated method includes an input to receive a communication session request. The communication request is received and includes an associated identifier. A session identifier corresponding to the communication session is stored. The session is associated with a primary queue corresponding to a mode of the incoming communication request. The session is assigned a position in the primary queue. The system estimates a primary hold time associated with the primary queue position. The system estimates an alternative hold time associated with the communication session if continued via a second communication mode and a corresponding queue position in a secondary queue associated with the second communication mode. A queue selection query prompt is generated to determine a desired queue in accordance with the primary and alternative hold times. A queue selection is received and this selection specifies whether the primary queue or a secondary queue is to be used. The queue selection establishes a continued communication session via the first communication mode or the second communication mode in accordance with the selection. A secondary queue position is offered for assignment in the secondary queue corresponding to the initial queue position.

In another example embodiment, logic is encoded to receive a remote communication session request via a first communication mode, which session request is associated with an identifier. The logic is further encoded to store session identifier data corresponding to the communication session in an associated data storage. The logic is further encoded to assign a primary queue position in a primary queue to the communication session. The logic is further encoded to estimate a primary hold time associated with the primary queue position and to estimate a first alternative hold time associated with the communication session if continued via a second communication mode and a corresponding queue position in a secondary queue. The logic is further encoded to estimate a second alternative hold time associated with the communication session if continued via a third communication mode and a corresponding queue position in a tertiary queue associated therewith. The logic is further encoded to generate a queue selection query corresponding to the primary hold time relative to the alternative hold times. The logic is further encoded to receive a queue selection specifying a selection of the primary queue, the secondary queue or the tertiary queue. The logic is further encoded to establish a continued communication session with the first communication mode, the second communication mode or the third communication mode in accordance with a received queue selection and to assign a secondary queue position in the secondary queue or a tertiary queue position in the tertiary queue corresponding to the initial queue position. The logic is further encoded to associate the continued communication session with a corresponding queue in accordance with the queue selection.

### DETAILED DESCRIPTION

Incoming product, service or technical support requests are suitably initiated by an incoming phone call from an individual in need of assistance. More recently, support may be initiated by sending an e-mail, frequently to an address such as support@company.com. As another alternative, a support session may be initiated by commencement of a chat session. In an example of such a session, a company has a website or web address via which a user can request a person-to-person communication session. In yet another alternative for support, a user initiates a support request by filling out a template, suitably provided as a website page.

Each type of support session employs a different communication mode to put a user in touch with a support person. Telephonic support has a potential of quickly connecting the user to the support person, and once a session is commenced, verbal communication provides a fast, easy and effective support connection. A downside of telephonic communication is human resource costs associated with staffing support lines. Staffing for peak calling periods means that support personnel may sit idle during off-peak periods. When there is insufficient staffing for incoming calls, callers are either forced to wait in a queue, directed to call back later, prompted for call back information when support personnel are available, or directed to leave a voicemail message stating their problem and contact information for a return call. Another downside of call-based systems is frustration of certain users relative to actual or prompt access to a human being. This may be particularly prevalent in connection with less technologically sophisticated users, or users with extremely time sensitive problems.

An automated queue handling system alleviates some of the afore-noted problems relative to incoming support phone calls. Such a system suitably provides information to the user relative to their situation. Such information may include their position in a queue or an approximate hold time. The user may be invited to call back, leave a message, or provide call-back information for a return call, sometimes while leaving some details relative to the problem at hand to allow the support personnel to prepare in advance of the return call. Another option is to provide to the user alternative support contact options, such as by navigation through a menu of voice mail prompts to reach prerecorded solutions for common problems. Certain support systems may employ different levels of support. By way of example, a first level of support staff may be trained to handle the most common and less technical support questions. More complex questions or issues may be escalated to a higher level of support where staff is more skilled, or skilled in specialized areas. Systems that obtain information relative to a particular issue can be manually or automatically moved to different support level. Various aspects of queue solutions may be available in combinations of the afore-noted features, which are suitably implemented in support call centers, but are potentially integrated into some of the alternative support communication modes noted below.

E-mail initiated support has an advantage of being a quick, efficient and easy. However, e-mail support requires access to a computer, smartphone or other e-mail capable device and access to an e-mail network, as well as sufficient user sophistication to utilize the same. A downside is that there may be a considerable lag between transmission of an initial request and an ensuing response. Also, electronic communication may be impossible when the only available device is the one for which support is needed. Inadequate information may require several back-and-forth exchanges to achieve a desired result. An advantage is that there is little lost productivity on either side in connection with idle time while waiting for a response. Another advantage is that users and support personnel can by located anywhere where e-mail is available, thus allowing remote support options including a support personnel located in lower-cost areas or countries.

Chat sessions, such as those commenced on web portals, like e-mail, have an advantage insofar as users and support personnel can be located almost anywhere. Like a calling queue, chat request are suitably queued up for efficient allocation to support personnel as they become available. Also, information such as estimated wait time and a current position in a chat queue may be made available to a user. A disadvantage of chat sessions is that, like e-mail, users must have access to hardware, software and a network to allow access, as well as the technological sophistication to use the same. Another potential disadvantage of chat sessions is that many are currently completed via character-based communication. Data entry speed, such as that associated with poor typists, can lengthen considerably the duration of a support session. Also, poor spelling or grammar, possibly attributed to non-native speakers involved in a chat session, can also cause delayed or erroneous responses. Some of these concerns can be alleviated by implementing multimedia chat, such as via audio chat or audio-visual chat. However, such systems require more technical resources, and are more difficult and expensive to implement. They may also introduce more problems relative to language barriers, including different dialects or regional accents.

Template based support requests suitably provide fields to be filled out to a user. Such fields may include user contact information, identification of a product or service at issue, identification of product or service source, identification of a date of purchase, or the like. Information is suitably gleaned with selections made from preselected choices, which choices may be associated with a particular product, service or other issue. Choices are also suitably structured in a tree format to allow for refinement of a particular item of interest. Templates also suitably include free form data entry, such as allowing a user to describe a problem in their own words. Template data entry provides a mechanism wherein certain, pre-defined solutions can be automatically communicated to the user via the current interface, e-mail, regular mail, or the like. A template is also suitably implemented as a gateway leading to an email, a phone call or a chat session, such as detailed above. Like e-mail and chat sessions, online template interfaces require sufficient hardware, software, network access and user sophistication to work effectively. Insofar as a human may ultimately have to respond, problems noted above may also factor in.

From the forgoing, it will be appreciated that there are many different communication modes that are available. Often companies will provide two or more support options to their customers or users. Support may be handled more efficiently in one mode relative to another, or may be handled by a different group with fewer or more resources in one mode relative to another. Users may commence a support request via their preferred route, not knowing which alternative communication routes may be available. A user may know that there are alternative communication routes, but not appreciate the relative wait times for each. Information relative to various wait times can prompt a user to choose an alternative route, even if that route is perhaps less desirable. Also, a user may be reluctant to lose their position in their hold queue in order to transition to an alternative communication mode. A user may not appreciate advantages associated with an alternative communication mode relative their particular concern. For example, electronic communication capabilities may allow for a support person to receive device information, including status information or screen shots, or may allow for support personnel to remotely login to a user's device to remotely control or otherwise address a problem. Electronic communication may also allow support personnel to configure a device, or upload or download software, data files or configuration files.

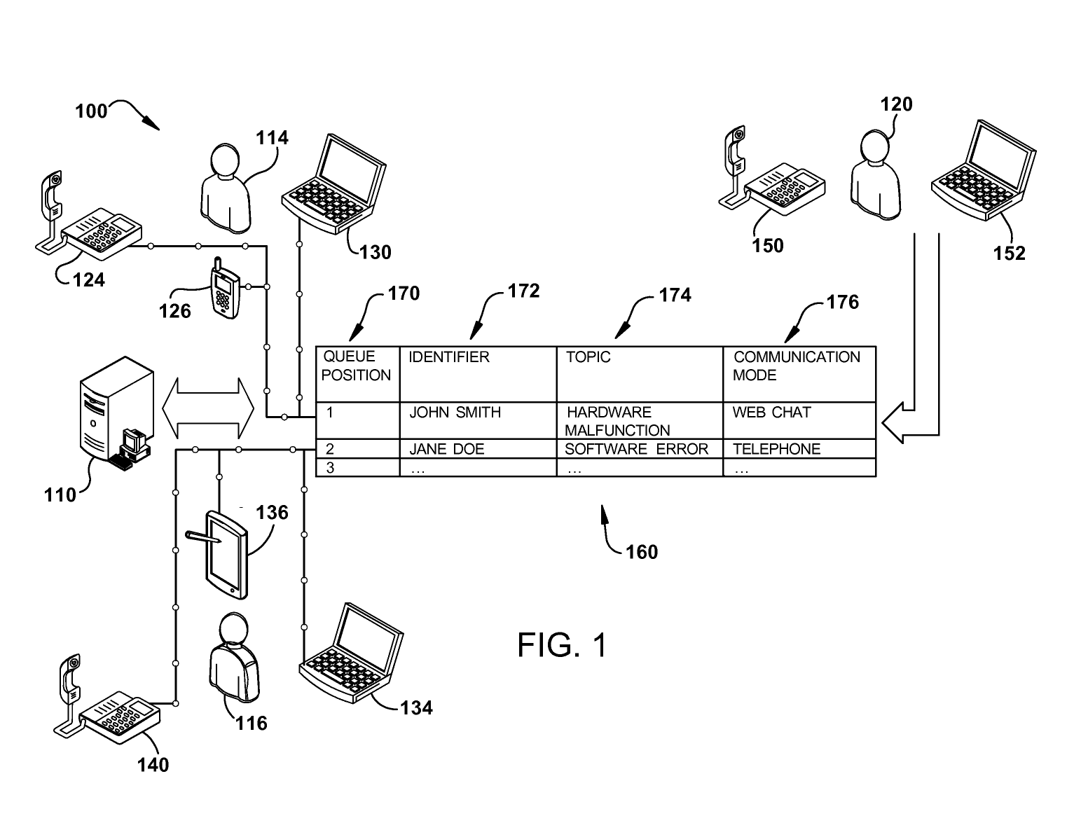

FIG. 1 illustrates an example embodiment of a system that facilitates accomplishing efficient selection or implementation of various support communication modes such as those detailed above. A support system 100 suitably includes at least one server 110 used as a gateway to users requesting support. Illustrated in FIG. 1 are representative users 114 and 116, one or both of which seek support on a product, service or other area of interest. While automated support answers may be available relative to some or all of a particular inquiry, a frequent goal relative to an inquiry is to connect with support personnel, such as support person 120 in the illustration. It will be appreciated that two or more support personnel are frequently employed in connection with a support system. As noted above, support personnel may be relegated to a specific product, service, area, communication mode or level of support. In other instances, support personnel may handle inquiries from more than one area or via more than one communication mode.

In the example of FIG. 1, user 114 has communication options including a telephone 124, a smartphone 126 or a computer 130. User 116 has communication options including a computer 134, a tablet 136 and a telephone 140. Support person 120 has access to a telephone system 150 as well as a computer 152 in the illustrated embodiment.

In the illustration of FIG. 1, users, as well as support personnel, are associated in connection with a support queue 160. In the example, support queue 160 includes multiple queue entries in a first-in-first-out relationship. Data for each queue position 170 is suitably associated with information relative to an incoming communication from a user. In the illustration of FIG. 1, support queue 160 is suitably associated with a primary queue, such as a primary support queue, such as a queue to which an initial user contact is routed. One or more contact modes are suitably associated with a queue. Alternatively, two or more queues such as queue 160 are suitably implemented. In another example, multiple queues are suitably associated with a particular communication device, or set of devices, as will be detailed further below.

Queue information suitably includes an identifier 172. A user identifier suitably comprises a name, incoming phone number, IP address, MAC address, or other suitable identifier supplied manually by a user or intake person, or extracted from metadata associated with an incoming request.

In the example of FIG. 1, queue 160 also includes a topic area 174 associated with each inquiry. Topic areas are suitably populated from user input, such as via voice entry, keypad entry, text entry or selection from menu options. Also illustrated in the example of FIG. 1 is a communication mode area 176 that suitably includes information as to a communication mode associated with an incoming request.

In the example of FIG. 1, user 114 is identified in the queue as John Smith, currently associated with a web chat communication session in connection with a support request for a hardware malfunction. John Smith is the first user in the queue 160, and next up for support. User 116 is identified as Jane Doe, associated with a software error, and connected via telephone. As will be appreciated from the figure, each user has an associated queue position, and various communication options that are suitably associated with the same queue position in queue 160, or an analogous alternative queue associated with a different communication mode, and in the same or similar relative position as will be detailed further below.

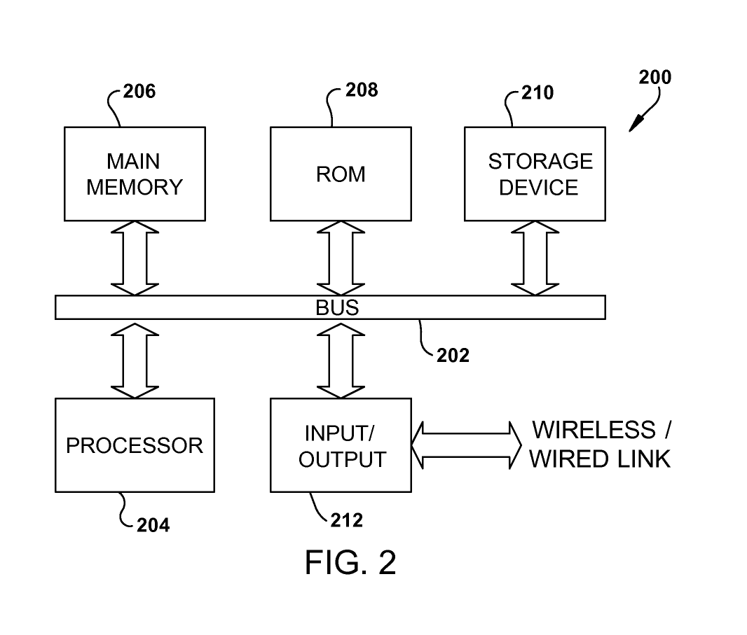

FIG. 2 is a block diagram illustrating an example of a suitable computer system 200 for use as one or more servers, such as that used in connection with server 110 of FIG. 1. Computer system 200 includes a bus 202 or other communication mechanism for communicating information and a processor 204 coupled with bus 202 for processing information. Computer system 200 also includes a main memory 206, such as random access memory (RAM) or other dynamic storage device coupled to bus 202 for storing information and instructions to be executed by processor 204. Main memory 206 also may be used for storing temporary variable or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk, optical disk, and/or flash storage, is provided and coupled to bus 202 for storing information and instructions. An input/output unit 212 facilitates communication via keyboard, mouse, network interface, or any other device outside of the system 200.

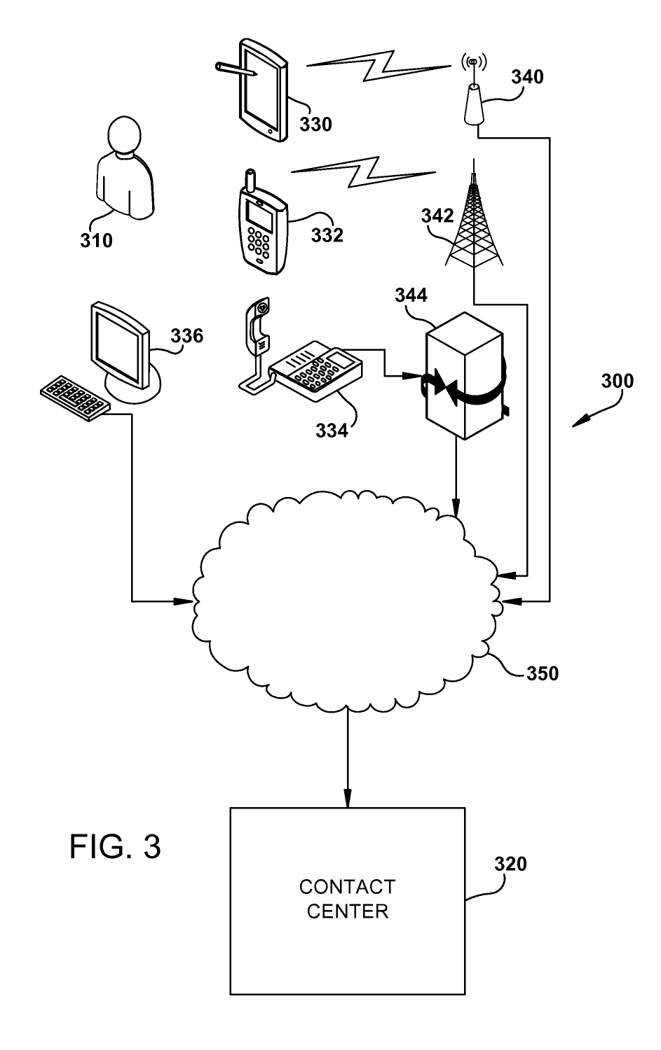

Turning now to FIG. 3, illustrated is an example embodiment of a system 300 for accomplishing a communication session between a user 310 and a contact or support center 320. It will be appreciated that the contact center 320 illustrated in the example suitably includes personnel, communications equipment, data processing equipment and a queue management system as described herein, and further detailed below. In the example of FIG. 3, user 310 has multiple modes of communication available for contacting the contact center 320. By way of further example, options include one or more of a tablet 330, mobile or smartphone 332, landline-connected phone 334 or computer 336. It will be appreciated that any wired or wireless audio, audiovisual or data connection is suitable for use in contacting a contact center. By way of further example, tablet 330 suitably communicates via a wireless network access point 340, phone 332 suitably communicates via a cellular network 342, phone 334 suitably communicate via a telephone network 344 and computer 336 suitably communicates via a network connection, such as a local area network, a wide-area network, or a combination thereof.

In the example illustration of FIG. 3, all communication will be appreciated to occur through cloud 350, which represents interconnection with the various data, voice or multimedia exchanges commonly available, including network connections such as the Internet. It will be appreciated that the particular interconnections illustrated in FIG. 3 are not exhaustive, and may include any wireless, optical or wired connection, or a hybridization thereof.

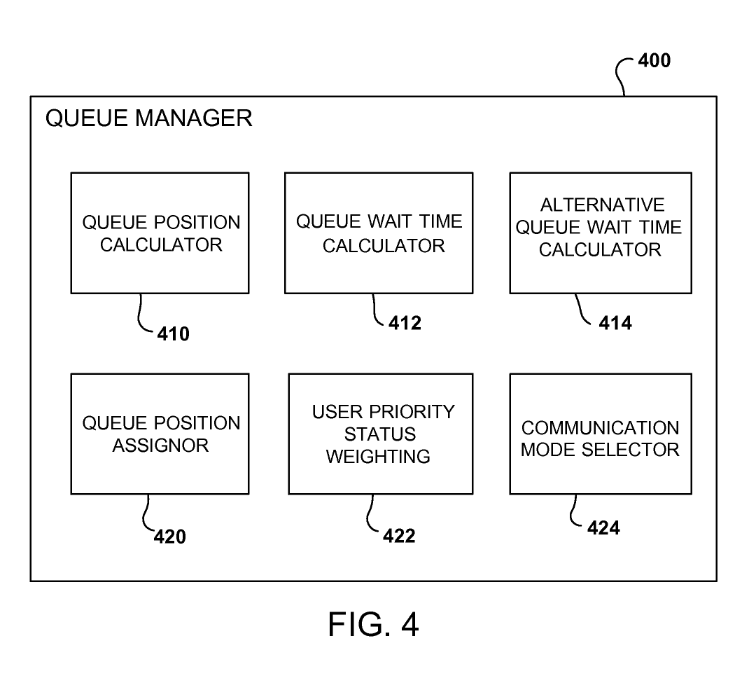

Turning now to FIG. 4, illustrated is function diagram of an example queue manager 400, suitably comprised within a server such as server 110 of FIG. 1. Functionality of queue manager 400 is suitably applied to one or more modes of communication, including audio, data or multimedia connections. Functionality of the queue manager includes a queue position calculator 410 operable to determine a location of a support session in an associated queue. Such a queue position is suitably dictated in connection with any suitable queuing system. In one example, contacts are queued in a first-in-first-out relationship, with an initial assignment of an incoming contact to a particular queue which then serves as a primary queue for the contact. As noted above, two or more alternative queues are suitably associated with a different device, or different set of devices, corresponding to an incoming request mode.

In another embodiment, additional factors are suitably implemented in connection with positioning a session within the queue. Such factors may include a priority level associated with a session. Elevated priority levels are suitably associated with larger or loyal customers, customers with urgent needs or customers who have paid for special or expedited treatment during support calls.

Also illustrated in FIG. 4 is a queue wait time calculator 412. The wait time calculator 412 suitably monitors factors such as a number of sessions that precede a given session for support time, a number of available support personnel, complexity of a particular problem, as well as a status associated with the user or their issue. In one embodiment, queue wait time is calculated for each session in a queue, and the information is periodically updated and relayed to respective users. By way of example, if an earlier session in the queue is completed, each subsequent queue position will be incremented accordingly. This change is reflected in a new queue position and adjusted wait time which is suitably communicated to the user. Also, one or more sessions in an alternative queue may have been completed, causing a modified queue position to be reflected if a change were to be made to the alternative queue. Thus, the user is suitably notified also of an updated wait time should a change be made to the alternative queue, which change is reflected relative to the new position in the current queue. If a user was not disposed to change queues, a significant modification to the wait time in the alternative queue may persuade them to now do so. Thus, a user is suitably enabled to determine their most desirable option relative to changing queues, or maintaining their position in their current queue.

FIG. 4 further illustrates an alternative wait time calculation unit 414. The unit 414 suitably checks wait times in alternative wait queues, such as wait queues associate with alternative modes of communication. By way of example, a user may initiate a call to a support center via telephone. The user is placed in a primary queue and prompted with a current wait time, such as estimated wait time or number of people ahead of them in a queue if they were to implement a web chat session instead. In another example, a user awaiting a support chat session may be apprised that a wait in a call cue is substantially less. In another example, a user waiting for commencement of a chat session is suitably prompted to enter initial information into a web template, which information will allow them to be placed in a different queue or repositioned within their current queue. A user is suitably prompted for anticipated wait times in more than one alternative queue.

In one embodiment, a queue position in a current queue is propagated to a corresponding queue position in one or more alternative queues associated with alternative communication modes. For example, if a user is currently queue position 5, an alternative wait time is suitably calculated assuming they were allocated queue position 5 in a queue associated with an alternative communication mode. As another example, alternative wait times may be calculated in accordance with a position relative to the size of the respective queues. In a particular situation, a user may be 5^{th} out of 10 in their current queue, so a calculation is made for anticipated wait time in an alternative queue to be 11 out of 22. In any case, the user is apprised that they are able to keep a corresponding position in an alternative queue if a change is decided.

Queue position assignor unit 420 suitably functions to assign a queue location to one or more sessions in one or more queues. By way of example, a user is associated with a queue session and an associated communications mode. Such a queue assignment is suitably a primary queue to which a communication session was associated, or suitably a subsequent queue to which a contact has previously been routed. The user is prompted with information relative to wait time in their current queue, as well as wait times in alternative queues as noted above. A user is then able to select whether an alternative queue, out of one or more options, is more desirable.

User priority status weight unit 422 suitably factors in a user status, such as may be associated with larger or loyal customers, customers with urgent needs or customers who have paid for special or expedited treatment. Such priority status suitably interacts with queue position calculator 410, queue weight time calculator 412 and alternative queue wait time calculator 414 in connection with their functionality as detailed above.

Also illustrated in FIG. 4 is a communication mode selector unit 424 which serves to associate a user session, and a selected or assigned queue, with a corresponding mode of communication. For example, a user may migrate from a web chat queue to a telephone queue, and the web chat session is suitably closed, and a phone connection with the user initiated.

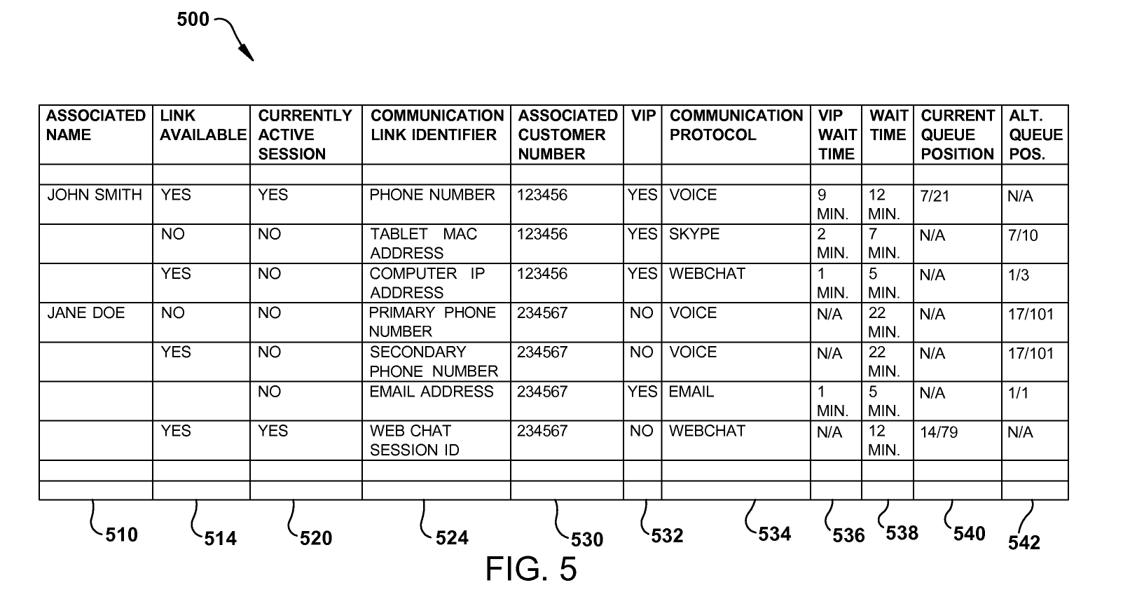

Turning next to FIG. 5, illustrated is another example of a session 500 wherein content is depicted in table form. Multiple sessions are illustrated, including one for user John Smith and one for user Jane Doe. Session information suitably includes an associated identifier 510, such as a name, or any other suitable identifier. Each identified user is suitably associated with more or more alternative communication modes 514. A currently active communication session 520 is also associated with available communication modes. A communication link identifier 524 suitably denotes a mode type, such as phone, IP address, e-mail address, MAC address, or the like.

In the illustration of FIG. 5, an identifier, such as customer number 530, is implemented. Such information provides one example of a mechanism by which a user may be identified as meriting expedited or special treatment relative to communication options or queue hold times. Enhanced status is suitably indicated at 532, and may be associated with all communication modes of a customer as with John Smith, or specified communication modes such as paid, expedited e-mail support for Jane Doe. A communication protocol 534 is also suitably associated with a session or user, as is a wait time 538 and a VIP wait time 536 relative to those sessions or users that merit special treatment. A position in a current queue 540 and a prospective position in an alternative queue 542 are also tracked. In the illustration, a prospective position in an alternative queue at 542 is suitably a corresponding location to that of a current queue, such as the same queue position or relative queue position, or any suitable positioning scheme which may take into account other factors for positioning, such as resources, cost or incentivizing future use of other communication modes.

The depiction of FIG. 5 is by way of example only. It will be appreciated that a subset or superset of information relative to a user or session is suitably considered, including available resources, product involved, service involved, or any other suitable factor.

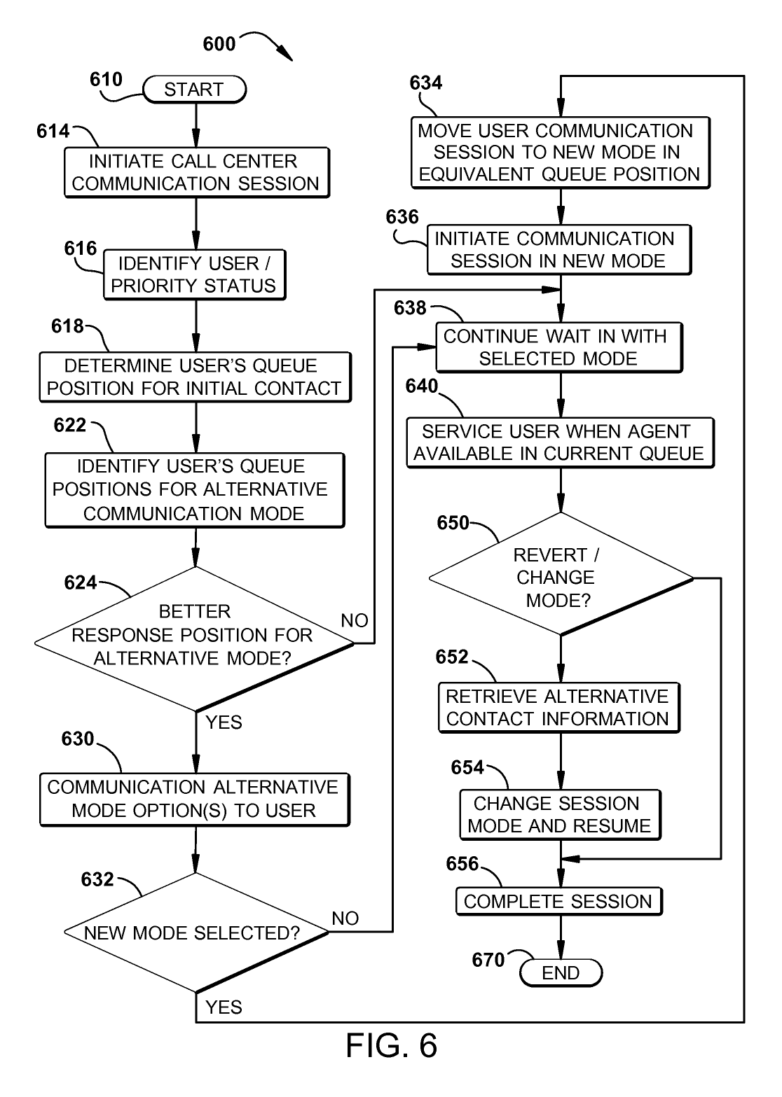

Turning now to FIG. 6, depicted is a flow diagram of an example queue management system 600, suitably implemented in connection with systems and environments detailed above. The flow diagram commences at 610, and a communication session is initiated with a call center at 614. By way of further example, a user may place a technical support call into a published number, click on a web chat icon on a product support page, or commence any suitable support session option including those detailed above. Next, at 616, an identifier is associated with a user and associated session. As noted above, suitable identifiers are user-supplied, or determined from data or metadata corresponding to the associated session or communication mode. Also, a user's priority status is suitably determined once suitable identification has been completed

Next, at 618, a user's initial queue position associated with the user identifier and communication mode is identified. Next, at 622, queue positions or queue times for available, alternative queues are determined. If alternatives, or better alternatives, are determined at 624, flow suitably passes to 630 wherein information relative to user options is communicated. If a user selects a new mode at 632, a communication session is migrated to an associated queue of the newly selected mode at 634, and the continuation of the session via the selected mode is commenced at 636. In the event that no alternative modes, or no better mode options exist at 624, the process suitably progresses directly to 638 in connection with the initial contact mode and associated queue. It will be appreciated from the forgoing that a user is therefore enabled to either actively or passively maintain their current queue position, or select a different queue and associated position in accordance with their preferences insofar as they are provided with sufficient information on which to base their decision.

Next, at 640, a user and associated session is suitably serviced when support resources are available relative to an associated queue position.

Illustrated at 650 is an example of a further option for reverting to a prior mode, or changing to another alternative mode in connection with information available. Alternative contact information is obtained at 652 and a session is migrated to the new mode at 654. A session is suitably completed at 656, and the process ends at 670

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus comprising:
an input operable to receive a communication session request via a first communication mode in accordance with an associated identifier;
logic coupled to the input operable for storing, in an associated data storage, data comprising a session identifier corresponding to the communication session;
the logic further operable to assign a primary queue position in a primary queue to the communication session;
the logic further operable to estimate a primary hold time associated with the primary queue position;
the logic further operable to estimate an alternative hold time associated with the communication session if continued via a second communication mode and a corresponding queue position in a secondary queue associated therewith;
the logic further operable to generate a queue selection query corresponding to the primary hold time relative to the alternative hold time;
the input further operable to receive a queue selection specifying a selection of a secondary queue;
the logic further operable to be responsive to the received queue selection to establish a continued communication session via the second communication mode in accordance therewith; and
the logic further operable to associate the continued communication session with a corresponding queue.

2. The apparatus of claim 1 wherein the logic is further operable to establish a primary queue position in accordance with a priority status associated with the user.

3. The apparatus of claim 1 wherein the first communication mode is via a first device type and the second communication mode is via a second device type.

4. The apparatus of claim 1 wherein the logic is further operable assign a secondary queue position in the secondary queue corresponding to the primary queue position.

5. The apparatus of claim 1 wherein the logic is further operable to adjust the estimate of the alternative hold time in accordance with a change in a status of at least one preexisting queue session.

6. The apparatus of claim 5 wherein the logic is further operable to adjust the position in the secondary queue in accordance with an adjustment of the position in the primary queue.

7. The apparatus of claim 1 wherein the logic is further operable to reestablish a communication session via the first communication mode from the second communication mode.

8. A method comprising:
receiving a communication session request via a first communication mode in accordance with an associated identifier;
storing, in an associated data storage, data comprising a session identifier corresponding to the communication session;
assigning a primary queue position in the primary queue to the communication session;
estimating a primary hold time associated with the primary queue position;
estimating an alternative hold time associated with the communication session if continued via a second communication mode and a corresponding queue position in a secondary queue associated therewith;
generating a queue selection query corresponding to the primary hold time relative to the alternative hold time;
receiving a queue selection specifying a selection of the primary queue or a secondary queue;
establishing a continued communication session via the second communication mode in accordance a received queue selection; and
associating the continued communication session with a corresponding queue.

9. The method of claim 8 further comprising assigning a queue position in accordance with an associated priority status.

10. The method of claim 8 further comprising receiving the communication session request via a first communication mode associated with a first device type and wherein the second communication mode is associated with a second device type.

11. The method of claim 10 further comprising assigning a secondary queue position in the secondary queue corresponding to the primary queue position.

12. The method of claim 8 further comprising adjusting the estimate of the alternative hold time in accordance with a change in a status of at least one preexisting queue session.

13. The method of claim 12 further comprising adjusting the position of the associated user in the secondary queue in accordance with an adjustment of the position of the associated user in the primary queue.

14. The method of claim 8 further comprising reestablishing a communication session via the first communication mode from the second communication mode.

15. Logic encoded in at least one tangible media for execution and when executed operable to:
receive a remote communication session request via a first communication mode in accordance with an associated identifier;
store, in an associated data storage, data comprising a session identifier corresponding to the communication session;
assign a primary queue position in a primary queue to the communication session;
estimate a primary hold time associated with the primary queue position;
estimate a first alternative hold time associated with the communication session if continued via a second communication mode and a corresponding queue position in a secondary queue associated therewith;
estimate a second alternative hold time associated with the communication session if continued via a third communication mode and a corresponding queue position in a tertiary queue associated therewith;
generate a queue selection query corresponding to the primary hold time relative to the alternative hold times;
receive a queue selection specifying a selection of the primary queue, the secondary queue or the tertiary queue;
establish a continued communication session via the first communication mode, the second communication mode or the third communication mode in accordance with a received queue selection;
assign a secondary queue position in the secondary queue or a tertiary queue position in the tertiary queue corresponding to the initial queue position; and
associate the continued communication session with a corresponding queue in accordance with the queue selection.

16. The logic of claim 15 further operable to receive the remote communication request as a telephone call.

17. The logic of claim 15 further operable to establish the second communication session as a web chat session.

18. The logic of claim 15 further operable to assign a queue position in accordance with a priority status associated with the user.

19. The logic of claim 15 further operable to receive the remote communication request as a requested web chat session.

20. The logic of claim 17 further operable to reestablish a communication session via the first communication mode from the second communication mode.
